(19) United States
(12) Patent Application Publication
(10) Pub. No.: US 2014/0294498 A1
(43) Pub. Date: Oct. 2, 2014

(54) FURNITURE COMPONENT JOINING SYSTEM

(71) Applicant: WILLIAM ROBERT LOGAN, Tracy, CA (US)

(72) Inventor: WILLIAM ROBERT LOGAN, Tracy, CA (US)

(21) Appl. No.: 13/855,267

(22) Filed: Apr. 2, 2013

(51) Int. Cl. F16B 12/46

(52) U.S. Cl. CPC F16B 12/46
USPC 403/376

(57) ABSTRACT

A dovetail joining system for furniture provides hardware components that embody the male and/or female components of the dovetail joint, and these components are secured to structural components using standard screws. Male dovetail fittings have a cross-sectional profile complementary to a dovetail groove, and are secured to furniture components with screws, and range in length from a bar with a large plurality of screw holes, to a short component having a single screw hole. A block fitting comprises a rectangular solid tube with each surface having a female dovetail channel dimensioned to receive a male dovetail fitting. A male right angle dovetail fitting has orthogonal arms, each arm slidably secured in a dovetail channel formed in a separate furniture component.

### CROSS-REFERENCE TO RELATED APPLICATIONS

This application claims the priority date benefit of Provision Application No. 61/621,710, filed Apr. 9, 2012.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to fastening systems for joining structural members and, more specifically, for fastening systems used in furniture construction.

2. Description of Related Art

The sliding dovetail joint, if manufactured with sufficient precision, is very easy to assemble, and it results in a tight, strong, durable, aesthetically-acceptable product. The dovetail joint has been used throughout history because of its unique physical properties of transforming pullout forces to lateral tensile forces, thus using the inherent strength of the materials being joined, to resist joint failure. The dovetail joint has not been commonly used in recent years for standard quality products due to the costs involved in purchasing equipment capable of machining both joining members, or in the cost of hand labor to craft the joint.

Nonetheless, manufacturers of furniture designed to be user-assembled, called “RTA” (ready-to-assemble) furniture, have long sought a workable dovetail joint for use in their furniture kits. However, variations in the depth of the mortise cut, caused by differences in thickness among individual pieces of drawer-front panel stock, provoke continual problems with the mortise and tenon fit. For example, using the outer face of the drawer-front panel as the reference surface, if a thicker than usual piece of stock is run through a router to cut the mortise grooves, the grooves will be deeper than usual. Conversely, thinner pieces of stock will end up having shallower mortise grooves. This results in some mortise grooves grasping the more standard-shaped tenons differently than others, which may cause loose joints and out-of-square construction. In custom furniture manufacturing, these problems can be cured by planing each piece of panel stock to the exact same thickness, or by making a custom-shaped tenon for each joint. However, this added step involves more machine time, as well as more machines used in the production line. But in mass-produced RTA products, custom machining is not cost effective. It is for these and other reasons the RTA furniture industry has yet to be able to enjoy the benefits of dovetail joinery.

### BRIEF SUMMARY OF THE INVENTION

The present invention generally comprises a modified dovetail joining system primarily for furniture and similar constructions. A salient feature of the joining system is the provision of hardware components that embody the male and/or female components of the dovetail joint, and these components may be secured to structural components using standard screws. The hardware components are machined or otherwise formed with dimensional accuracy, thus avoiding a great deal of the problems associated with dovetail joints described above. In addition, the tools required to employ the invention are reduced to a router bit and a drill bit, obviating the need for more expensive woodworking tools.

In one aspect, the joining system provides a male dovetail joint fitting having a cross-sectional profile of a rhomboid with two opposed parallel surfaces with two opposed obtuse surfaces of equal dimensions extending therebetween. At least one screw hole extends through the opposed parallel surfaces, and at least one standard screw is secured through the hole to a furniture part such as a frame component or panel. Thus the furniture component is provided with a male dovetail part without requiring any extensive woodworking, except drilling the holes for the screws which is a simple task. The male dovetail fitting is typically secured to an end of a board or panel, and then slidably engaged in a dovetail groove formed in an adjacent furniture component. Many examples of the utility of this and other arrangements are given below.

The length of the male dovetail fitting may range from a bar that extends longitudinally that has a large plurality of screw holes, to a short component having a single screw hole. In all cases the ends of the male dovetail fittings are radiused smoothly to engage a dovetail groove without binding or catching.

A further aspect of the invention is the provision of a block fitting, comprised of a longitudinally extending bar having a rectangular or square cross-sectional profile. Each longitudinally extending surface of the bar is provided with a longitudinally extending dovetail channel, the channel having a narrow opening and a broader interior surface, as is known in the prior art. The dovetail channel is dimensioned to receive the male dovetail fitting described above with a close-tolerance sliding fit. A plurality of screw holes extend through the bar between the opposed interior surfaces of opposed dovetail channels, so that any male dovetail fitting may be secured in one of the channels using the standard screws.

The length of the block fitting may range from a short component having two screw holes to a long bar having a large plurality of screw holes. The block fitting may be placed in the interior corner of a furniture construction and used to join furniture components having a right angle relationship, such as frame or panel components. After male dovetail fittings are secured to the furniture components, they may be slidably engaged in the channels of the block fitting to establish the proper 90° association and spatial relationship, and the standard screws are then installed to lock the furniture components in place. Many examples of the utility of this and other arrangements are given below.

In another aspect, the invention provides a male right angle dovetail fitting having the cross-sectional profile described above, but formed as two arms extending at a 90° angle from a common vertex. The right angle fitting is placed within an interior corner of a furniture construction, and each arm may be slidably secured in a dovetail channel formed in a furniture component or in one of the block fitting described above, whereby the two components are secured at right angles. The standardized screws may be installed to lock the furniture components in place.

The male dovetail fittings and the block fitting may be formed of Delryn™ or similar material by automated machine tools or molded in finished form of similar plastic or polymer materials. These materials are easily cut and modified with standard woodworking tools to enable the parts to be adapted to particular fastening design situations. These parts may also be pierced and pinned in place with standard pneumatic pintackers, nailers, and staplers. In addition, Delryn™ and like materials are self-lubricating, enabling easy sliding translation in close tolerance fit situations, without wheels or bearings, and can form a secure joint that is dimensionally stable and highly resistant to the effects of moisture.

A salient feature of this joining system is that it is easily disassembled, without damaging or degrading the furniture components. In contrast, most RTA joining systems known in the prior art cannot be disassembled more than a few times without substantially impairing the usefulness and integrity of the joining system and the furniture components.

### BRIEF DESCRIPTION OF THE DRAWING

FIG. 1 is a perspective view of one embodiment of the male dovetail fitting of the present invention.

FIGS. 2-4 are orthographic projection views of the male fitting depicted in FIG. 1.

FIG. 5 is a perspective view of an extended length male dovetail fitting embodiment of the invention.

FIGS. 6 and 7 are perspective views of two further embodiments of the male dovetail fitting having minimum length dimensions.

FIG. 8 is an exploded view depicting the fitting of FIGS. 1-5 joined to an end surface of a board.

FIG. 9 is an exploded view of the board and fitting assembly of FIG. 8 being joined to a dovetail groove machined in another furniture component.

FIG. 10 is a cross-sectional elevation of the joint formed by the components shown in FIG. 9, and FIG. 11 is a plan view of the dovetail groove shown in FIGS. 9 and 10.

FIG. 12 is a perspective view of a furniture part equipped with a male dovetail fitting being slidably installed in a dovetail channel of another furniture part.

FIGS. 13 and 14 are perspective views depicting a single-screw male dovetail fitting used a shelf support.

FIG. 15 is a perspective view showing two furniture components being joined by a row of single-screw male dovetail fittings.

FIG. 16 is an exploded perspective view depicting the block fitting of the invention being joined to a furniture component using an elongated male dovetail fitting of the invention.

FIG. 17 is an enlarged perspective view of one end of a block fitting as shown in FIG. 16.

FIGS. 18 and 19 are orthographic views of the top and end surfaces of the block fitting of FIGS. 16-17.

FIG. 20 is a perspective view depicting a further use of the male dovetail fitting as a spacer secured to a furniture component.

FIG. 21 is an exploded perspective view depicting the assembly of two furniture components using the male dovetail spacer fitting of FIG. 20.

FIG. 22 is a cross-sectional view showing two furniture components joined by a male dovetail spacer fitting of FIGS. 20 and 21.

FIG. 23 is a perspective view of a male right angle dovetail fitting joined to a pair of furniture components extending orthogonally with respect to a support component.

FIG. 24 is a perspective view of orthogonal furniture components joined by a male right angle dovetail fitting.

FIGS. 25 and 26 depict a further use for the male dovetail fitting, in which the fitting is installed in a dovetail groove in a side surface of a furniture component, and a hinge pin is secured in the endmost screw hole and thereafter used to pivotally secure the furniture component to another structural component.

### DETAILED DESCRIPTION OF THE INVENTION

The present invention generally comprises a modified dovetail joining system having hardware components that embody the male and/or female components of the dovetail joint, and these components may be secured to structural components using standard screws. Thus a great deal of woodworking time and machining is eliminated, and in addition the secure dovetail joint formed by the invention may be disassembled and reassembled without degrading the structural components or the dovetail fittings.

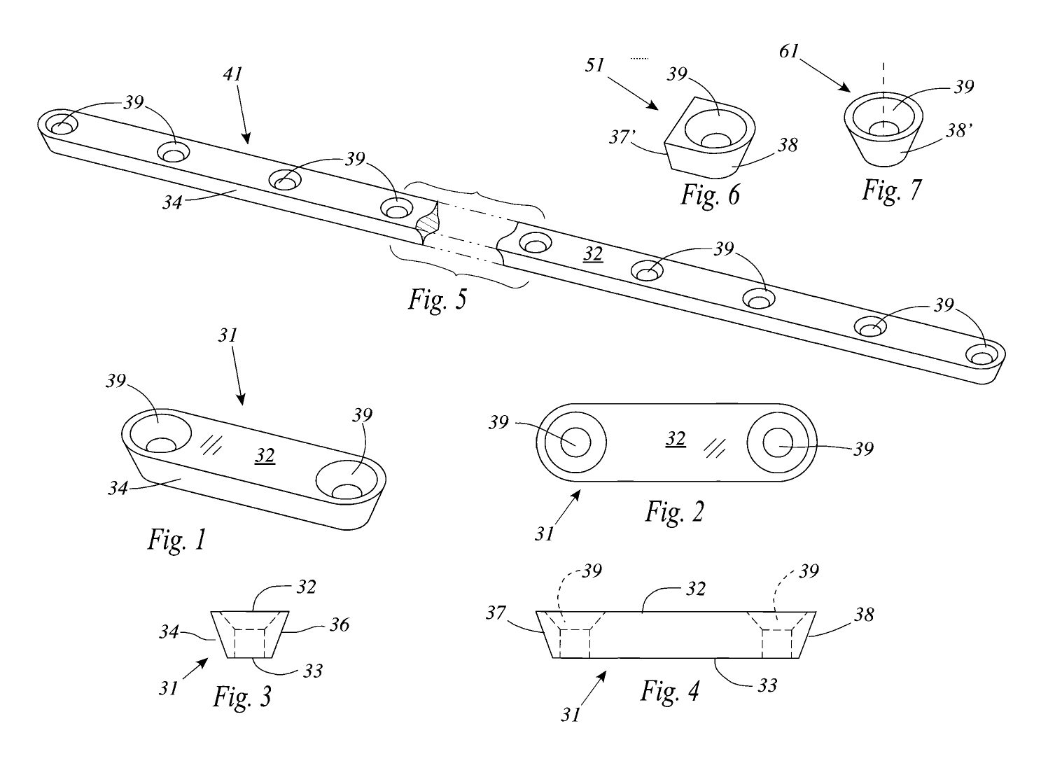

With regard to FIGS. 1-4, one embodiment of the invention is a male dovetail fitting 31, comprised of a solid bar having parallel top and bottom surfaces 32 and 33, and obtuse side surfaces 34 and 36, and end surfaces 37 and 38. Note that the side and end surfaces are dimensioned and inclined at a standard dovetail angle, such as ½ inch, 14° dovetail that is widely used in the prior art. The side surfaces and end surfaces are fully radiused at their junctures, forming rounded ends that may be inserted into dovetail channels without binding or catching. The fitting 31 has a length that is approximately six times the height, but the dovetail angle and fitting aspect ratio are not limitations of the invention. A pair of countersunk screw holes 39 extend through the fitting between the top and bottom surfaces and are positioned adjacent to the ends of the fitting 31.

In a further embodiment, a male dovetail fitting 41, shown in FIG. 5, has the same surfaces 32-34 and 36 in the same relative relationships described with respect to fitting 31. However, the length of fitting 41 is several time greater than fitting 31, and the number of screw holes 39 is accordingly increased. Note the center-to-center spacing of the holes 39 is substantially the same as in the fitting 31. This common spacing is one aspect of the modularity of the components of the joining system.

With reference to FIGS. 6 and 7, further embodiments 51 and 61of the male dovetail fitting both comprise minimal length components for specific uses described below. The fitting 51 includes the same top and bottom surfaces 32 and 33, as well as rounded end 38 joining sides 34 and 36, but end 37′ is cut off generally orthogonally at a point adjacent to the single screw hole 39. In the fitting 61 the top and bottom surfaces 32 and 33 are joined by a rounded end 38′ that is radiused and curved entirely about the fitting to form a truncated right conical object in which the single screw hole 39 is coaxial with the right conical shape. The differences in the outer conformations of fittings 51 and 61 result in a functional distinction: fitting 51 of FIG. 6 may be inserted into a dovetail channel only if end 38 leads into the channel, whereas fitting 61 of FIG. 7 may be lead into a dovetail channel from and angle about the axis of the fitting.

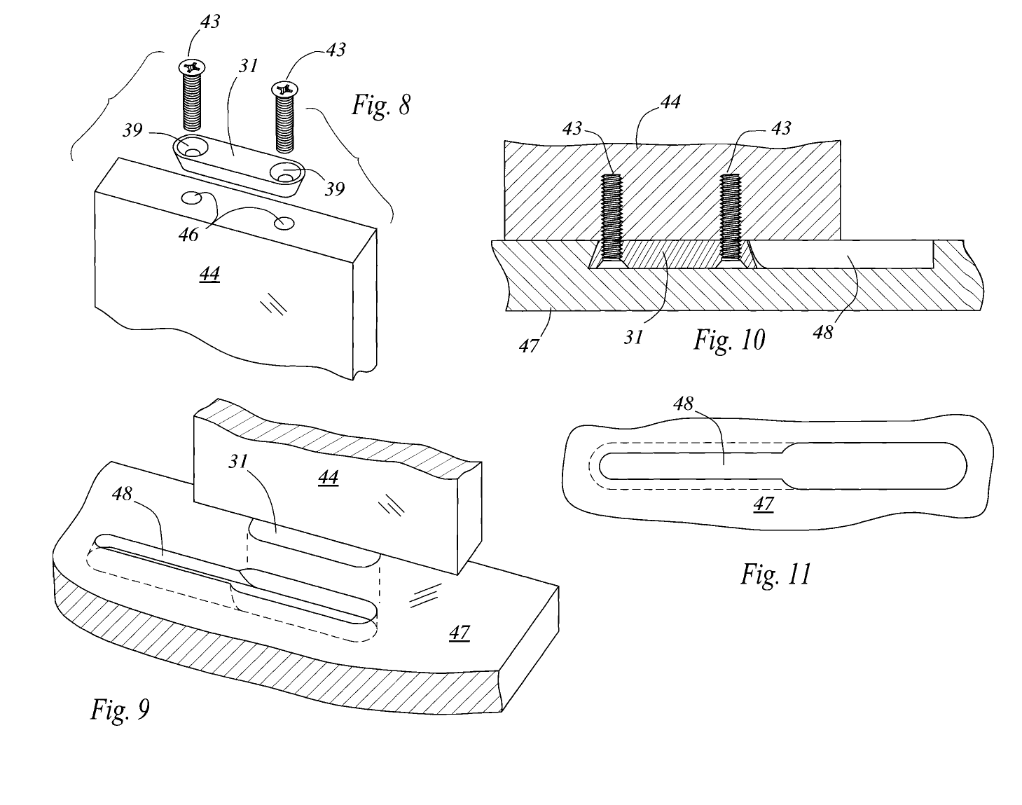

With regard to FIGS. 8-11, one typical use of the male dovetail fitting 31 is initiated by securing the fitting 31 to the square-cut end of a structural component 44 such as the board shown. A pair of pilot holes 46 are drilled into the end surface of component 44, ideally by using a jig that assures the proper spacing and orientation of the holes in the end surface. A pair of screws 43 are extended through holes 39 of fitting 31 and secured in the holes 46 in the board. In a preferred embodiment the holes 39 and the pilot holes 46 are sized to accept a standard furniture screw, such as the Euro 5 mm standard screw, and are spaced 32 mm apart.

As shown in FIGS. 9-11, a panel 47 is prepared for joining by routing a dovetail groove 48 into the surface of a panel (FIG. 11). The groove 48 is formed by a router bit that machines a slot that has a cross-sectional shape complementary to the cross-sectional shape of the fitting 31. The fitting 39 is then inserted into the entry of dovetail groove 48 and slidably engaged in the dovetail portion, forming a sliding dovetail joint between board 44 and panel 47. Since this joint does not inherently lock in place, another component such as a cabinet part or additional fastener must be employed to immobilize the dovetail joint.

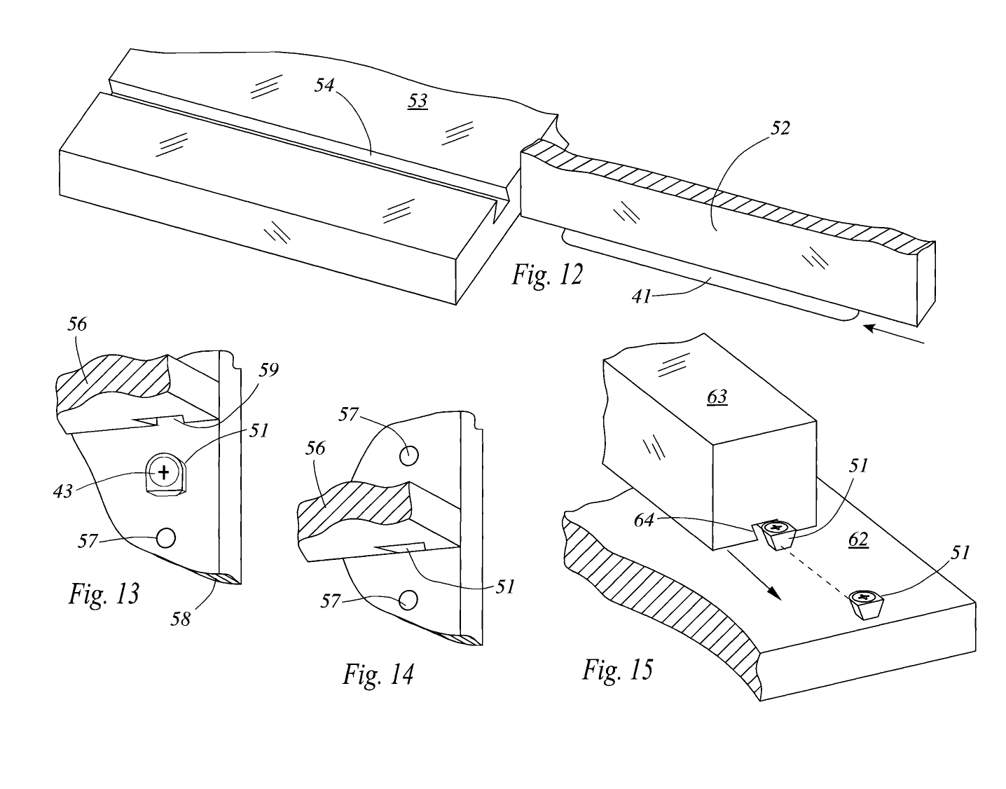

With regard to FIG. 12, one typical use of the male dovetail fitting 41 depicted in FIG. 5 involves securing the fitting 41 to the square-cut end surface of a furniture component 52, using the same steps as shown in FIGS. 8 and 10, with a larger number of screws 43 to fill the larger number of screw holes 39 in fitting 41. A dovetail groove 54 is routed into the surface of a furniture component 53, beginning at the end surface of the component 53. The fitting 41 is then slidably installed in the groove 54 to assemble the components 52 and 53. As one example only, the component 53 may comprise a desktop or tabletop panel, and the component 52 may comprise a side panel of a desk or table. The longer format of the fitting 41 provides a tight and secure joint along a major dimension of the assembled furniture components, resulting in a solid, long-lasting furniture assembly.

Note also that the male dovetail fitting 41 may be employed as a drawer guide for a sliding drawer of a furniture construction, with the fitting 41 secured to the bottom surface of an opening that receives the drawer, and with a dovetail groove milled or routed in the bottom of the drawer and disposed to slidably engage the fitting 41.

Referring to FIG. 13, one advantageous use of the male dovetail fitting 51 of FIG. 6 is to support a shelf panel 56 within a cabinet. The interior surface of the cabinet side 58 is provided with a plurality of holes 57 spaced apart vertically, as is known in the prior art, except that holes 57 are dimensioned to accept the screws 43 described previously. A screw 43 is employed to install a male dovetail fitting 51 in a selected hole 57 at the desired shelf height. The shelf panel 56 is provided with a dovetail slot 59 milled or routed in the side surface thereof. When the shelf 56 is placed in the cabinet, the slot 59 accepts the fitting 51 therein, as shown in FIG. 14, so that the shelf is supported by fitting 51. (Of course, two fittings 51 are used at each side of the shelf 56, and the same arrangement is employed at the opposite side of the shelf.) The resulting shelf mounting is locked in place, in that it cannot be slidably removed from the cabinet without first lifting the shelf to disengage the fitting 51. In addition, the shelf height is adjustable by relocating the fitting 51 in the desired hole 57.

A further use of the male dovetail fitting 51, shown in FIG. 15, is intended to economize on the use of longer fittings 41 where it is feasible. A plurality of male dovetail fittings 51 are installed on the interior surface of a panel 62 and aligned along a common centerline. A structural component, such as batten 63, is provided with a dovetail groove 64 milled or routed in one surface thereof. The batten may be installed by slidably engaging the dovetail groove 64 on the multiple male dovetail fittings 51, as shown by the motion arrow, whereby the batten is joined firmly to the panel 62.

Note that in the applications of FIGS. 13-15 (and elsewhere) for male dovetail fitting 51, the male fitting 61 may be substituted with equal efficacy.

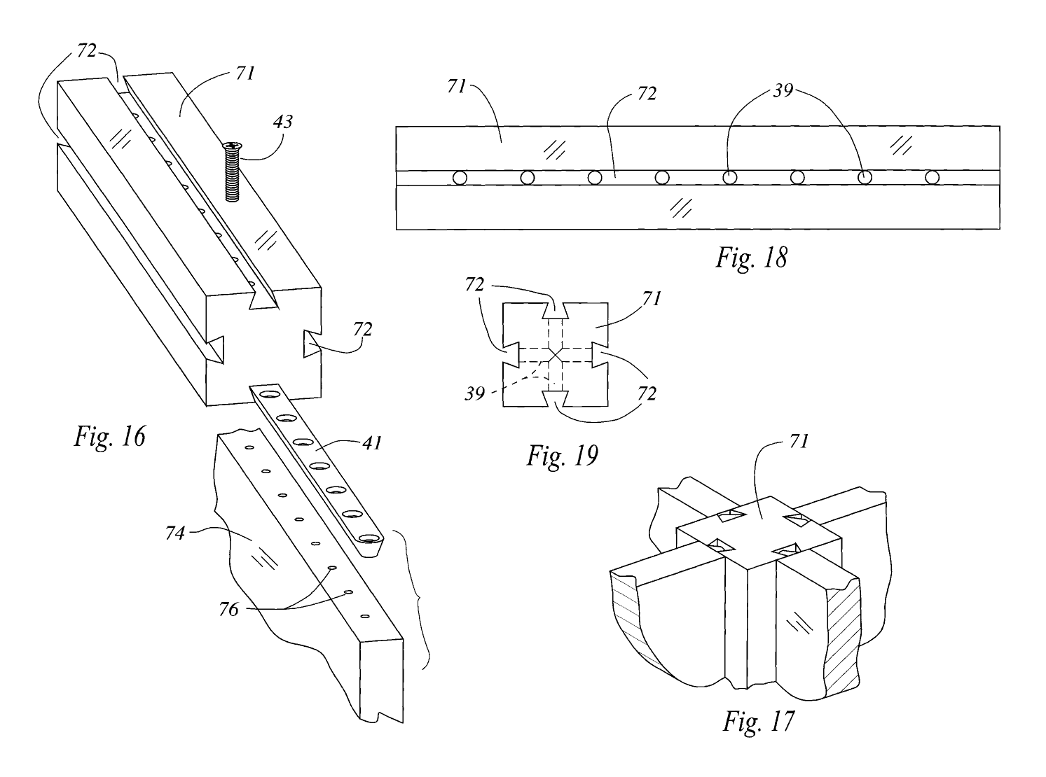

A further aspect of the invention, as shown in FIGS. 16-19, is the provision of a block fitting 71 which embodies female dovetail grooves. The block fitting 71 has a cross-sectional profile that is rectangular, preferably square, with square-cut end surfaces. The longitudinally extending surfaces of the fitting are each provided with a dovetail groove 72 extending the length thereof and dimensioned to have a standardized dovetail shape that is complementary to the male dovetail fittings described herein. A plurality of screw holes 39 extend through the block fitting 71 from each dovetail groove 72 to its opposite groove, the screw holes being dimensioned to accept the screws 43 described previously. (The screw holes of orthogonally-related sides are aligned in registration with each other, so that they intersect at the central core of the block fitting 71.) Once again, the screw holes are spaced apart a standardized distance, such as the 32 mm Euro standard. This is a further facet of the modular aspect of this dovetail joining system.

In one exemplary use of the block fitting 71, a male dovetail fitting 41 is secured to the side surface of a panel 74 by screws 43 received in screw holes 76 in the side surface. The fitting 41 is then slidably introduced into one of the female dovetail grooves 72 of fitting 71, thus securing the panel 74 to the fitting 71. As shown in FIG. 17, up to four panels may be thusly joined, all of them extending in precise orthogonal relationship that is set by the orthogonally related sides of the fitting 71.

The fitting 71 may be formed of Delryn™ or similar material that is lubricious, easily machined and cut, and inexpensive. Note that the fitting 71 may be produced in any convenient length, and/or may be cut to any desired length using standard woodworking tools. Also, it is apparent that any of the male dovetail fittings 31, 41, 51, or 91 may be joined to any of the dovetail grooves 72 of the fitting 71, in such a large number of combinations and permutations that they cannot all be described herein.

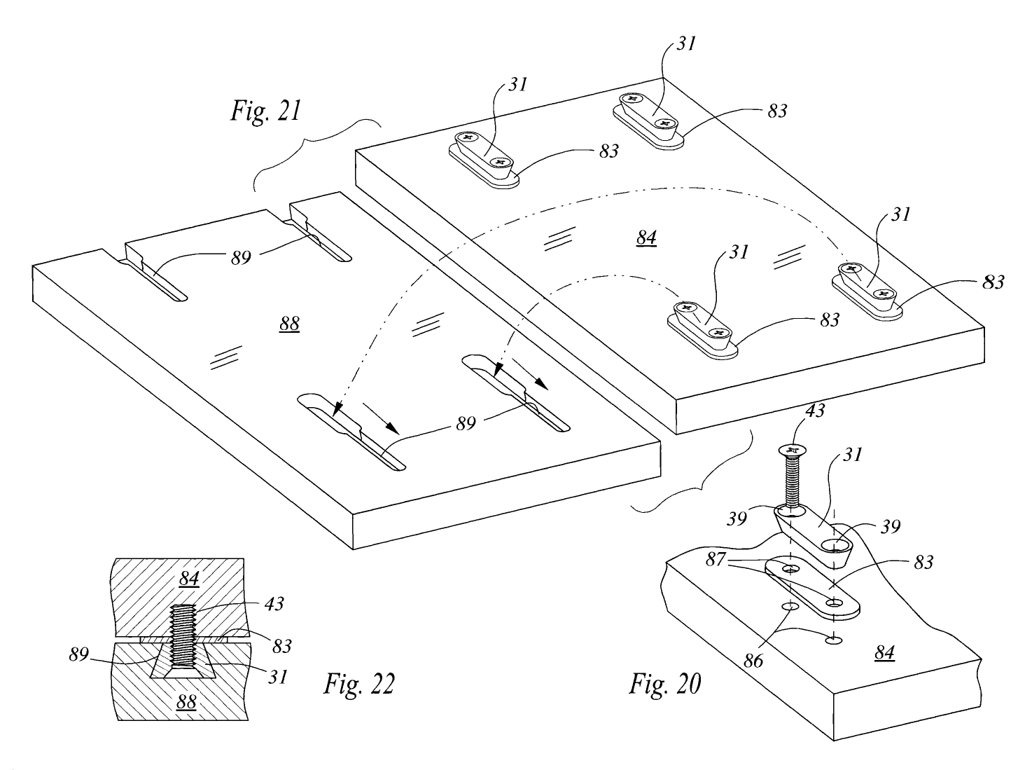

A further use of the male dovetail fittings of the invention, depicted in FIGS. 20-22, is intended to define a fixed spacing between two furniture components that are secured by the dovetail joining system. A furniture panel 84 is provided with a plurality of male dovetail fittings 31, using screws 43 secured in aligned holes 86 in the panel 84. A spacer plate 83 having a defined thickness, aligned pass-through holes 87, and a profile similar to fitting 31, is placed between the panel 84 and the fitting 31 as the fitting is secured to the panel. Thus the fittings 31 are not secured flush with the panel 84, but are spaced apart therefrom by the thickness of the spacers 83.

As shown in FIG. 21, another furniture component 88 is provided with a plurality of dovetail grooves 89 milled or routed into the surface thereof and positioned in obverse registration with the male dovetail fittings 31 of panel 84. One of the panels is then inverted and positioned to insert the fittings 31 into the dovetail grooves 89, and the panels are translated relative to each other as shown by the motion arrows so that the fittings firmly engage the dovetail grooves. As a result the panels 84 and 88 are secured together in a spaced-apart relationship, as shown in FIG. 22. This spacing arrangement may be useful, for example, in joining panels of differing wood types to avoid thermal expansion problems and the like.

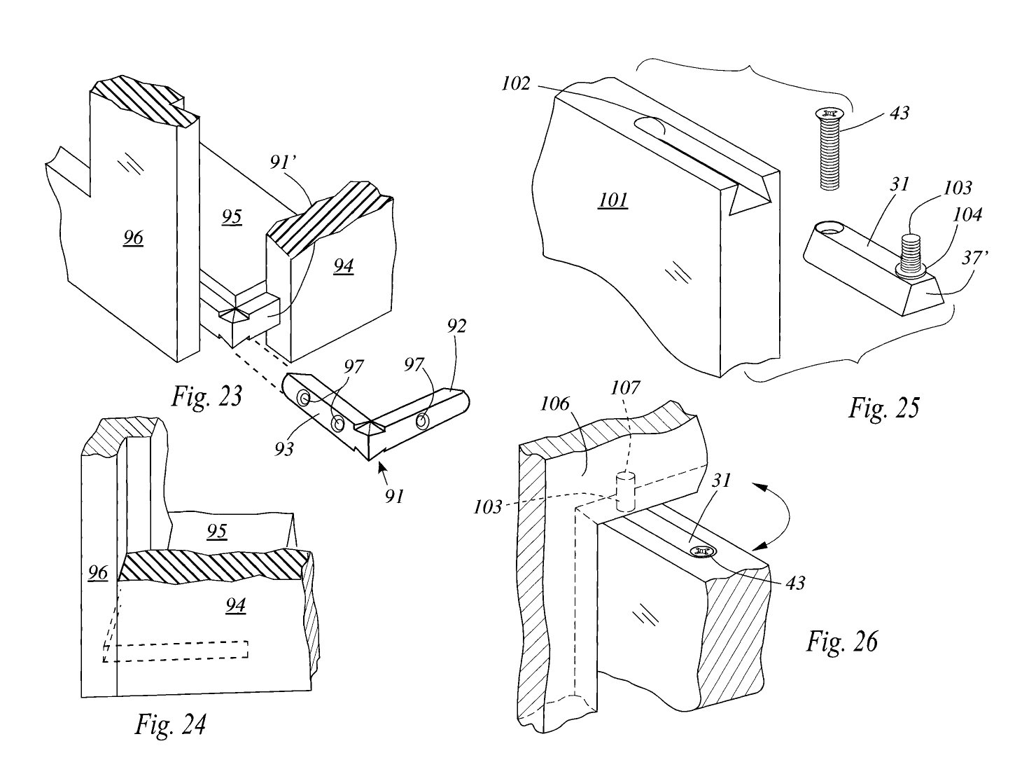

The dovetail joining system further provides a male right angle dovetail fitting 91, as shown in FIG. 23. The fitting 91 includes two arms 92 and 93 extending from a common vertex, each arm having a male dovetail profile as described previously. Each arm also includes at least one screw hole 97 that accept the standard screws and have the standard spacing described and shown previously. The arm 93 may be secured to a furniture component 96, such as a cabinet bottom, using screws 43 and suitable pilot holes (not shown) in the component 96. The board 95 may be provided with a dovetail groove extending longitudinally in the side confronting the component 96, and the furniture component 94, such as a cabinet finished end is also provided with a dovetail groove in its broad, interior-facing surface. The arm 93 is slidably secured in the dovetail groove of component 95, thus joining the components 95 and 96 (cabinet bottom and face frame, for example). Thereafter the arm 92 of fitting 91 is slidably joined to the dovetail groove in component 94 (finished end), thus joining the three components and forming a corner joint that is entirely hidden from view, even from the interior of the cabinet. The face frame may have a rabbit joint at the location where the finished end is slid into the face frame to allow the dovetail groove to be hidden from view. In this manner three individual furniture components may be secured in a single assembly (FIG. 24) using a single right angle fitting 91, providing an economy of parts and woodworking time. Note that the fitting 91 assures that the components will all be joined precisely at right angles, and the joint is entirely hidden from view from the exterior of the assembly.

With regard to FIGS. 25 and 26, the male dovetail fitting 31 may also be employed in a hinge arrangement to hang doors in cabinets and other furniture. A door panel 101 is provided with a dovetail groove 102 milled into a vertex of the panel so that one end of the groove opens directly to a side surface of the panel 101, and the groove opening opens to the orthogonally adjacent side surface, as shown in FIG. 25. A dovetail fitting is modified by cutting one end (as in fitting 51 of FIG. 6) to form a square-cut end 37′, with the length of the fitting 31 equal to the length of the dovetail groove 102. Thus the end 37′ is substantially flush with the side surface of the panel 101. The cabinet opening for the door is provided with a hole 107 extending upwardly therein. To hang the door panel 101, the round end of fitting 31 is inserted into the open end of the dovetail groove 102, and a hinge pin 103 with washer 104 is inserted into the screw hole of fitting 31 adjacent to the box end 37′. Pin 103 is then inserted into hole 107, and screw 43 is then installed to secure the fitting 31 in the groove 102. (This process is repeated for the lower hinge pin as well). The door panel is then free to pivot about the hinge pins 103, as shown by the motion arrow of FIG. 26.

All of the dovetail fitting described herein may be fabricated of a polymer plastic material such as Delryn™, which is mentioned for its low cost, ease of machining, dimensional stability, lubricity, and susceptibility to woodworking tools such as saws and drills. Other equivalent or generic materials may also be used.

The modular dovetail joining system of this invention has the following advantages:
1. The male and female fittings form a universal joint with a very wide range of applications.
2. The dovetail joining system is an affordable and user friendly system for use in the woodworking and manufacturing sectors. It is compatible with the 32 mm system of building cabinets and furniture. It is designed to be used in conjunction with 5 mm Euro screws and standard ½″×14° dovetail router cutters.
3. The male and female fittings form strong reliable mechanical joints.
4. The dovetail joining system can used as a permanent or temporary knockdown joint. It is optimal for Ready-to-Assemble (RTA) furniture and cabinetry.
5. The male and female fittings form joints that are blind or invisible.
6. The male and female fittings form stable long-lasting joints which are relatively impervious to corrosive forces such as rust, rot, mildew.
7. The male and female fittings form joints that are less susceptible to expansion and contraction issues than wood mechanical joints, and is therefore less prone to “freezing up”.
8. The male and female dovetail fittings are easy to use, requiring little special equipment, and reap even bigger rewards when used by wood shops that employ standard modern woodworking equipment.
9. The male and female fittings form joints that are “forgiving” joints. Because the fittings rely on the use of the “French” dovetail continuous dado, they slide into position. The tightness of fit can also be adjusted by tightening or loosening the “system” screws, or by removing material from the bottom of the fitting.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A dovetail joining system for furniture and cabinet construction, including:
at least one male dovetail joint fitting dimensioned to be slidably received and secured in a dovetail groove of a first furniture component, said fitting having a cross-sectional profile that is complementary to the profile of the dovetail groove;
at least one screw hole extending through said male dovetail joint fitting and dimensioned to accept a threaded fastener to secure said male fitting to a second furniture component in protruding fashion, whereby said first and second furniture components may be joined together by engaging said male dovetail fitting in the dovetail groove of the first furniture component.

2. The dovetail joining system of claim 1, wherein said male dovetail fitting cross-sectional profile is a rhomboid with two opposed parallel surfaces with two opposed obtuse surfaces of equal dimensions extending therebetween, and said at least one screw hole extends between said opposed parallel surfaces.

3. The dovetail joining system of claim 2, wherein said male dovetail fitting has opposed ends that are fully radiused to form rounded ends to be inserted in the dovetail groove without binding or catching.

4. The dovetail joining system of claim 2, further including a plurality of said screw holes spaced generally equally along a longitudinal dimension of said male dovetail fitting.

5. The dovetail joining system of claim 1, wherein said male dovetail fitting comprises a right angle fitting having a pair of arms extending from a common vertex at an included angle of 90°, each of said arms having a cross-sectional profile that is complementary to the profile of the dovetail groove.

6. The dovetail joining system of claim 5, said at least one screw hole extending through each of said pair of arms, and a plurality of said threaded fasteners for securing said pair of arms to orthogonally related side surfaces of said second furniture component.

7. The dovetail joining system of claim 6, further including a pair of said first furniture components, each having a dovetail groove therein to receive and retain one of said arms of said right angle fitting, whereby said pair of first furniture components are joined to said second furniture component in a mutually orthogonal relationship.

8. The dovetail joining system of claim 1, further including a female dovetail joint fitting having at least one dovetail groove extending therein and dimensioned to receive said at least one male dovetail fitting therein; and
at least one screw hole extending through said female dovetail joint fitting and dimensioned to accept a threaded fastener to secure said female fitting to a third furniture component.

9. The dovetail joining system of claim 8, wherein said female dovetail joint fitting comprises a rectangular solid tube having longitudinally extending side surfaces, with a dovetail groove extending longitudinally in each of said side surfaces.

10. The dovetail joining system of claim 9, further including a plurality of said screw holes extending through said rectangular tube from each dovetail groove to the opposed groove in the opposed side of the rectangular tube.

11. The dovetail joining system of claim 10, wherein said rectangular tube has a square cross-sectional profile.

12. A dovetail joining system for furniture and cabinet construction, including:
a female dovetail joint fitting having at least one dovetail groove extending therein and dimensioned to receive said at least one male dovetail component therein; and,
at least one screw hole extending through said female dovetail joint fitting and dimensioned to accept a threaded fastener to secure said female fitting to a furniture component.

13. The dovetail joining system of claim 12, wherein said female dovetail joint fitting comprises a rectangular solid tube having longitudinally extending side surfaces, with a dovetail groove extending longitudinally in each of said side surfaces.

14. The dovetail joining system of claim 13, further including a plurality of said screw holes extending through said rectangular tube from each dovetail groove to the opposed groove in the opposed side of the rectangular tube.

15. The dovetail joining system of claim 14, wherein said rectangular tube has a square cross-sectional profile.

16. The dovetail joining system of claim 13, further including at least one male dovetail joint fitting dimensioned to be slidably received and secured in any one of the dovetail grooves of said female dovetail joint fitting, said male fitting having a cross-sectional profile that is complementary to the profile of the dovetail groove.

17. The dovetail joining system of claim 15, wherein said male dovetail fitting comprises a right angle fitting having a pair of arms extending from a common vertex at an included angle of 90°, each of said arms having a cross-sectional profile that is complementary to the profile of the dovetail groove.
